(19) United States
(12) Patent Application Publication
(10) Pub. No.: US 2026/0274193 A1
(43) Pub. Date: Sep. 17, 2026

(54) AIRBAG DEVICE FOR VEHICLE

(71) Applicant: HYUNDAI MOBIS CO., LTD., Seoul (KR)

(72) Inventors: Dong Gil LEE, Yongin-si (KR); Dong Young KIM, Yongin-si (KR)

(73) Assignee: HYUNDAI MOBIS CO., LTD., Seoul (KR)

(21) Appl. No.: 19/378,833

(22) Filed: Nov. 4, 2025

(30) Foreign Application Priority Data
Mar. 11, 2025 (KR) 10-2025-0031459

(51) Int. Cl. B60R 21/233; B60R 21/207; B60R 21/231; B60R 21/239; B60R 21/00

(52) U.S. Cl. CPC B60R 21/233; B60R 21/207; B60R 21/23138; B60R 21/239; B60R 2021/0048; B60R 2021/2074; B60R 2021/23146

(57) ABSTRACT

An airbag device for a vehicle including: a seat mounted to the vehicle body to allow an occupant to sit thereon; a headrest mounted to the seat to support the occupant’s head; a housing disposed at the rear of the seat; and an airbag mounted to the housing and deployed to protect the occupant’s head or neck in the event of a collision of the vehicle body. The airbag includes: a first chamber inflated by fluid supplied from an inflator; and a second chamber in communication with the first chamber through a vent hole part and inflated by fluid supplied from the first chamber.

### CROSS-REFERENCE TO RELATED APPLICATION

This application claims priority from and the benefit of Korean Patent Application No. 10-2025-0031459, filed on March 11, 2025, which is hereby incorporated by reference for all purposes as if set forth herein.

### BACKGROUND

### Field

Exemplary embodiments of the present disclosure relate to an airbag device for a vehicle, and more particularly, to an airbag device for a vehicle, which may protect an occupant when a collision occurs from the rear of the occupant.

### DESCRIPTION OF THE RELATED ART

In general, an airbag of a vehicle is installed to protect an occupant in the event of a frontal collision. A collision detection sensor mounted on a front bumper of the vehicle detects a collision, and based on a detection signal, an electronic control unit (ECU) activates an inflator installed in a steering wheel, such that the vehicle airbag is deployed.

However, in the event of a rear collision, the occupant's occiput is not properly protected, which may lead to a significant loss of life.

In particular, an autonomous vehicle allows an occupant to freely change a front-facing direction of a seat, and thus the frequency of rear collisions may increase in addition to frontal collisions. In the event of a rear collision, the occupant may collide with a headrest due to inertia, and if the headrest is damaged by the impact, the occupant's neck may be injured. Accordingly, there is a need to resolve this issue.

The related art of the present disclosure is disclosed in Korean Patent Application Publication No. 1998-0059459 (published on October 7, 1998 and entitled "AIRBAG FOR PROTECTION AGAINST REAR COLLISION OF VEHICLE").

### SUMMARY

Various aspects of the present disclosure provide an airbag device for a vehicle, which may protect an occupant's head and neck when a collision occurs from the rear of the occupant.

An airbag device for a vehicle according to an aspect of the present disclosure includes: a seat mounted to a vehicle body and configured to allow an occupant to sit thereon; a headrest mounted to the seat and configured to support the occupant's head; a housing disposed at a rear of the seat; and an airbag mounted to the housing and configured to be deployed to protect the occupant's head or neck in the event of a collision of the vehicle body, wherein the airbag includes: a first chamber configured to be inflated by fluid supplied from an inflator; and a second chamber configured to be in communication with the first chamber through a vent hole part and inflated by fluid supplied from the first chamber.

The first chamber may be configured to be deployed from a rear of the headrest and inflated, and the second chamber may be configured to be deployed from a front of the first chamber and inflated.

The first chamber may be configured to come into contact with a rear surface of the headrest to support the headrest.

The second chamber, when fully inflated, may have an inverted U-shape when viewed from the front of the airbag.

The second chamber may include: an upper chamber configured to surround an upper side of the occupant's head; a first side chamber surrounding a first side of the occupant's head; and a second side chamber configured to surround a second side of the occupant's head, which is opposite the first side.

A lower end portion of the first side chamber and a lower end portion of the second side chamber may be positioned above the occupant's shoulders, respectively.

The first chamber may be in communication with each of the upper chamber, the first side chamber, and the second side chamber through the vent hole part.

The vent hole part may include: one or more first vent holes disposed in the first chamber and the first side chamber, respectively, to enable fluid flow between the first chamber and the first side chamber; one or more second vent holes disposed in the first chamber and the second side chamber, respectively, to enable fluid flow between the first chamber and the second side chamber; and one or more upper vent holes disposed in the first chamber and the upper chamber, respectively, to enable fluid flow between the first chamber and the upper chamber, wherein a total diameter of the one or more upper vent holes is greater than a total diameter of the first vent holes and a total diameter of the second vent holes.

The first chamber and the second chamber may be coupled by sewing to surround peripheries of the first vent hole, the second vent hole, and the upper vent hole.

The airbag device for a vehicle may further include a tether having a first side coupled to a front surface of the first chamber and a second side coupled to the housing to restrict upward movement of the first chamber during deployment of the first chamber.

The airbag device for a vehicle according to the present disclosure may protect an occupant's head and neck when a collision occurs from the rear of the occupant.

According to the present disclosure, the airbag may support the headrest from the rear to prevent damage to the headrest, thereby preventing the occupant's neck from bending.

According to the present disclosure, upward movement of the airbag is restricted by the tether, thereby restraining the occupant's ramping-up behavior more rapidly.

### BRIEF DESCRIPTION OF THE DRAWINGS

FIG. 1 is a view schematically showing an airbag device for a vehicle according to an embodiment of the present disclosure.

FIG. 2 is a view schematically showing a seat according to an embodiment of the present disclosure.

FIG. 3 is a view schematically showing a housing according to an embodiment of the present disclosure.

FIG. 4 is a view showing a state in which an airbag according to an embodiment of the present disclosure is deployed.

FIG. 5 is a view showing a state in which the airbag according to an embodiment of the present disclosure is fully inflated.

FIG. 6 is a block diagram showing the airbag device for a vehicle according to an embodiment of the present disclosure.

FIG. 7 is a perspective view showing the airbag according to an embodiment of the present disclosure.

FIG. 8 is a bottom view showing the airbag according to an embodiment of the present disclosure.

FIG. 9 is a side view showing the airbag according to an embodiment of the present disclosure.

FIG. 10 is a plan view showing the airbag according to an embodiment of the present disclosure.

FIG. 11 is a front view showing the airbag according to an embodiment of the present disclosure.

FIG. 12 is a view showing a tether during deployment of the airbag according to an embodiment of the present disclosure.

FIG. 13 is a side sectional view showing the tether during deployment of the airbag according to an embodiment of the present disclosure.

### DETAILED DESCRIPTION

Hereinafter, an airbag device for a vehicle will be described with reference to the accompanying drawings through various embodiments. In this process, the thickness of lines or the size of components shown in the drawings may be exaggerated for clarity and convenience of explanation. In addition, the terms as used herein are defined in consideration of functions thereof in the present disclosure, and this may change depending on a user or operator's intention or practice. Therefore, these terms should be defined based on the entirety of the disclosure set forth herein.

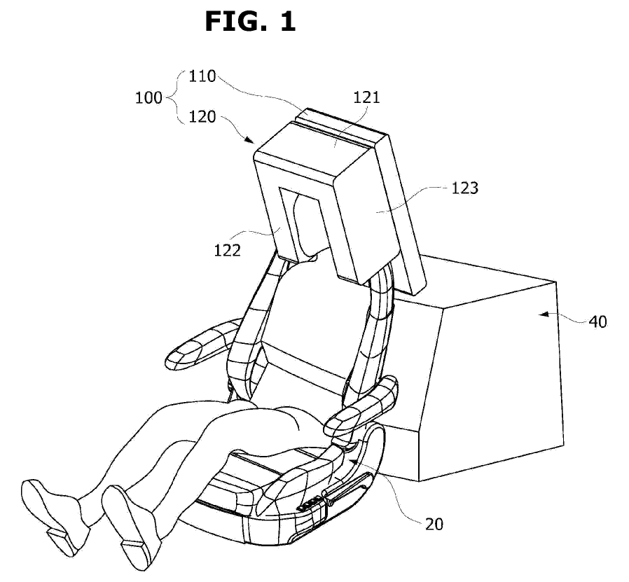

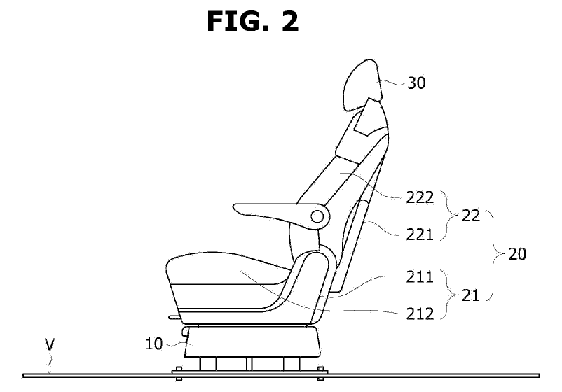

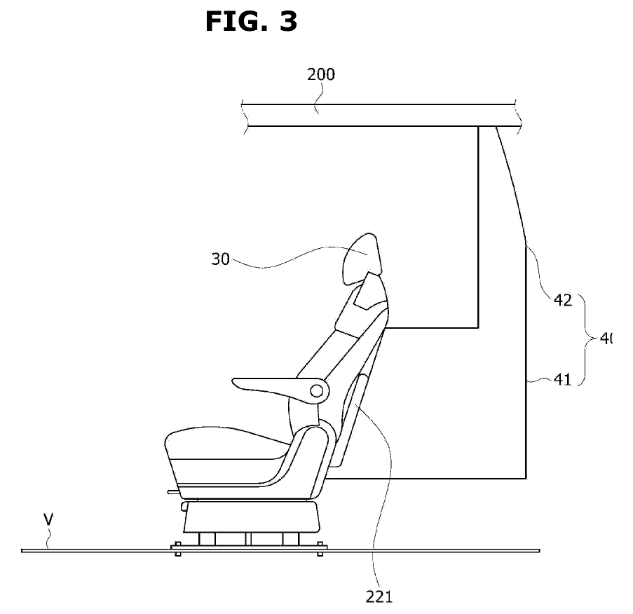

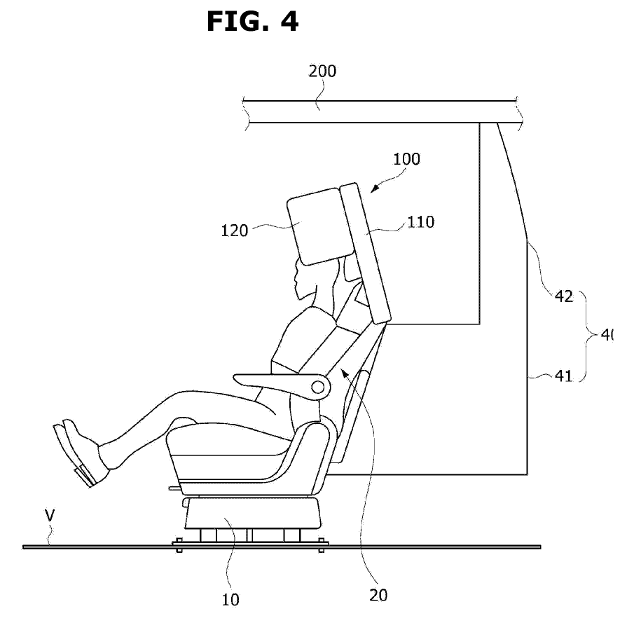

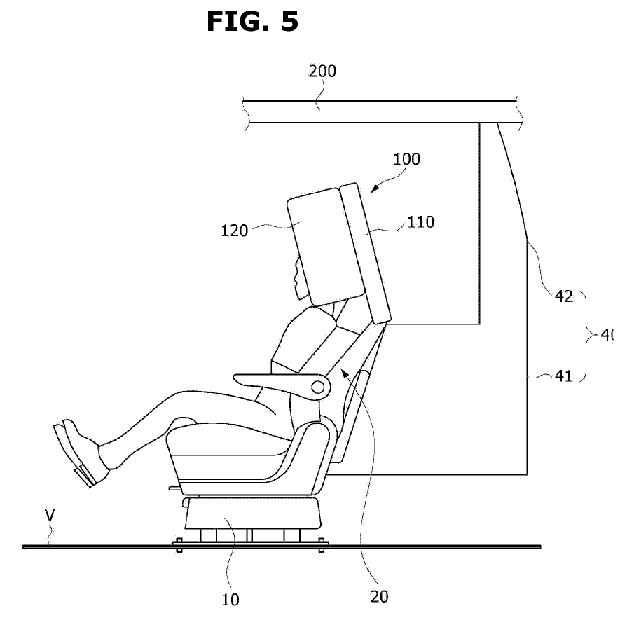

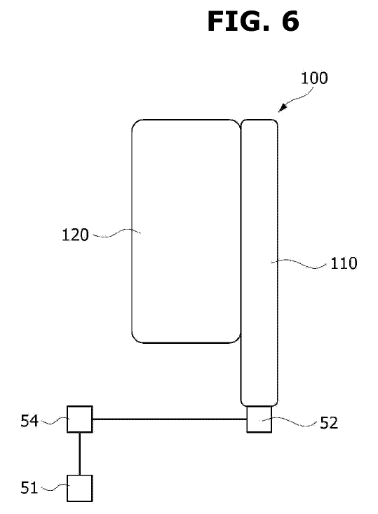

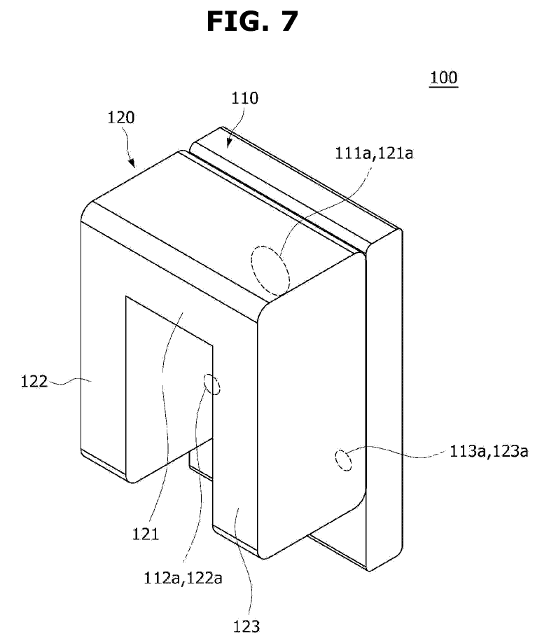

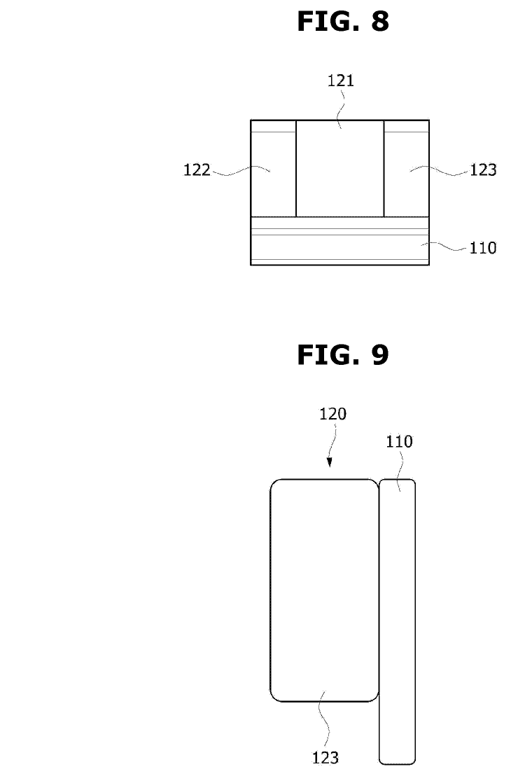

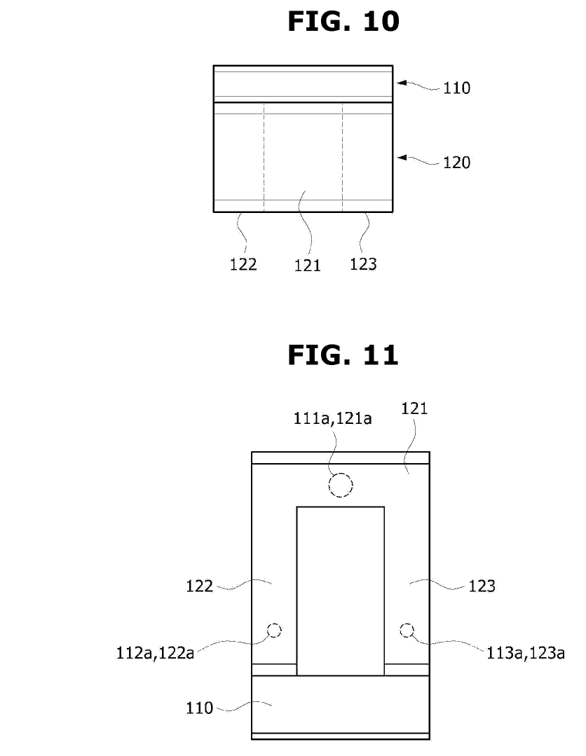

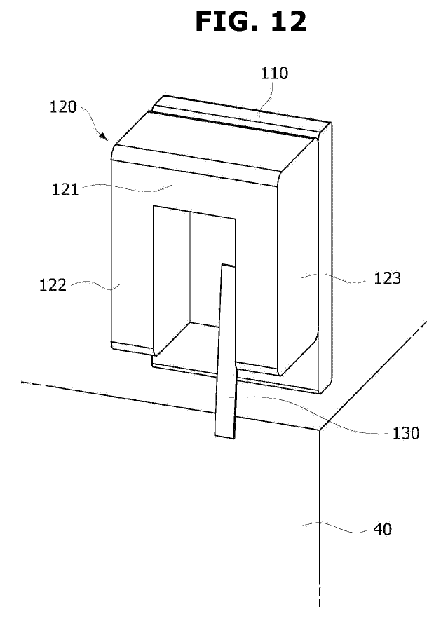

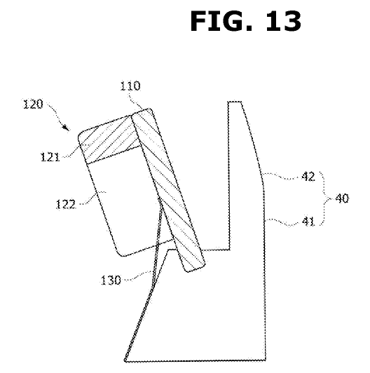

FIG. 1 is a view schematically showing an airbag device for a vehicle according to an embodiment of the present disclosure. FIG. 2 is a view schematically showing a seat according to an embodiment of the present disclosure. FIG. 3 is a view schematically showing a housing according to an embodiment of the present disclosure. FIG. 4 is a view showing a state in which an airbag according to an embodiment of the present disclosure is deployed. FIG. 5 is a view showing a state in which the airbag according to an embodiment of the present disclosure is fully inflated. FIG. 6 is a block diagram showing the airbag device for a vehicle according to an embodiment of the present disclosure. FIG. 7 is a perspective view showing the airbag according to an embodiment of the present disclosure. FIG. 8 is a bottom view showing the airbag according to an embodiment of the present disclosure. FIG. 9 is a side view showing the airbag according to an embodiment of the present disclosure. FIG. 10 is a plan view showing the airbag according to an embodiment of the present disclosure. FIG. 11 is a front view showing the airbag according to an embodiment of the present disclosure. FIG. 12 is a view showing a tether during deployment of the airbag according to an embodiment of the present disclosure. FIG. 13 is a side sectional view showing the tether during deployment of the airbag according to an embodiment of the present disclosure.

Referring to FIGS. 1 to 13, an airbag device for a vehicle according to an embodiment of the present disclosure includes a seat 20, a headrest 30, a housing 40, and an airbag 100. The airbag device for a vehicle according to an embodiment of the present disclosure may further include a position changing part 10.

The position changing part 10 is mounted to a vehicle body V and is capable of changing position within the vehicle body V. The position changing part 10 may be moved along a rail provided in the vehicle body V. The position changing part 10 may be rotated about a rotation axis. The seat 20, on which an occupant sits, may be moved forward and backward by the position changing part 10, and, if necessary, may be rotated to face another occupant.

The seat 20 may be directly mounted to the vehicle body V or mounted to the vehicle body V through the position changing part 10. An occupant may sit on the seat 20.

The headrest 30 may be mounted to the seat 20 and support the occupant's head. The headrest 30 may be adjustable in height to correspond to a height of the occupant's head. The headrest 30 may include a cushioning material.

The housing 40 may be mounted to the vehicle body V and disposed at the rear of the seat 20. The housing 40 being disposed at the rear of the seat 20 means that the housing 40 is disposed at the rear of the seat 20 regardless of whether the seat 20 is in a forward-facing or rear-facing state. Accordingly, when the seat 20 is in a forward-facing state, the housing 40 may be disposed behind the seat 20 relative to the vehicle body V and located at a rear side of the seat 20. When the seat 20 is in a rear-facing state, the housing 40 may be disposed in front of the seat 20 relative to the vehicle body V and located at a rear side of the seat 20.

A collision of the vehicle body V may be a rear collision or oblique rear collision of a vehicle when the seat 20 is in a forward-facing state, and may be a frontal collision or oblique frontal collision of the vehicle when the seat 20 is in a rear-facing state. A collision of the vehicle body V may be a collision that occurs from the rear of the occupant's head.

In a non-deployed state, the airbag 100 may be mounted to the housing 40, and in the event of a collision of the vehicle body V, the airbag 100 may be deployed from the housing 40 and inflated outside the housing 40 so as to protect the occupant's head or neck. The collision of the vehicle body V includes all collisions in which an impact of a set magnitude or greater is applied to a vehicle occupied by an occupant, such as a collision between vehicles and a collision between a vehicle and another object.

The airbag 100 may support the headrest 30 from the rear to prevent the headrest 30 from bending backward. Accordingly, the airbag 100 may prevent damage to the headrest 30, thereby preventing or mitigating injury to the occupant caused by bending of the neck.

In the event of a collision of the vehicle body V, the occupant may be thrown upward due to a ramping-up behavior. In this case, the airbag 100 may directly support the occupant's head or neck to prevent or mitigate injury to the occupant.

Referring to FIGS. 2 and 3, the seat 20 may include a seat cushion 21 and a seatback 22.

The seat cushion 21 may support the occupant's buttocks. The seat cushion 21 may be mounted to the position changing part 10. Movement or rotation of the position changing part 10 may change a position of the seat cushion 21 or rotate the seat cushion 21.

The seat cushion 21 may include a first seat securing portion 211, which is coupled to the position changing part 10, and a first seat cushioning portion 212, which is coupled to the first seat securing portion 211. The first seat securing portion 211 may include a metal material, and the first seat cushioning portion 212 may include a material capable of absorbing impact.

The seatback 22 may be connected to the seat cushion 21 and support the occupant's back. The seatback 22 may include a second seat securing portion 221, which is coupled to the first seat securing portion 211, and a second seat cushioning portion 222, which is coupled to the second seat securing portion 221. The second seat securing portion 221 may include a metal material, and the second seat cushioning portion 222 may include a material capable of absorbing impact.

The headrest 30 may be mounted on an upper portion of the seatback 22. The headrest 30 may be inserted into a groove formed in the second seat securing portion 221, and may be adjustable in height. The headrest 30 may support the occupant's neck or back of the head.

The housing 40 may include a first housing portion 41 and a second housing portion 42. The housing 40 may include a fixture installed in the vehicle.

The first housing portion 41 may be disposed at the rear of the seat 20, and may be fixedly installed to the vehicle body V. A highest point of the first housing portion 41 may be disposed lower than a lowest point of the headrest 30.

The second housing portion 42 may extend upward from the first housing portion 41. The second housing portion 42 may be adjacent to or in close contact with a roof 200. The second housing portion 42 may be disposed to be spaced apart from the headrest 30.

The second housing portion 42 may be adjustable in length. A length of the second housing portion 42 may be increased or decreased in a vertical direction. The second housing portion 42 may be movable in a horizontal direction along a rail formed in the first housing portion 41.

Referring to FIG. 6, the airbag device for a vehicle according to an embodiment of the present disclosure may include a sensor 51, an inflator 52, and a control unit 54.

The sensor 51 may detect an occurrence of a collision of the vehicle body V. The sensor 51 may be disposed at various points, such as a front surface, a side surface, and a rear surface of the vehicle body V, to detect in real time whether a collision of the vehicle body V has occurred. The sensor 51 may include a function of predicting an occurrence of a collision of the vehicle body V.

The inflator 52 may be mounted to the housing 40. The inflator 52 may be built into the first housing portion 41. The inflator 52 may be ignited by an ignition signal from the control unit 54 to discharge fluid, for example, gas, into the airbag 100.

The airbag 100 may be deployed by gas supplied from the inflator 52. The airbag 100 may pierce through a surface of the first housing portion 41 and be inflated at an initial stage of deployment.

The control unit 54 may receive a detection signal from the sensor 51 and control the inflator 52. In response to the sensor 51 detecting a collision of the vehicle body V and transmitting a detection signal to the control unit 54, the control unit 54, which has received the detection signal, may ignite the inflator 52. Accordingly, the inflator 52 may discharge gas.

The inflator 52 and the airbag 100 may be built into an airbag case (not illustrated) provided in the first housing portion 41. An upper portion of the airbag case may be open, and the open upper portion of the airbag case may be covered by a surface of the first housing portion 41. During deployment of the airbag 100, the surface of the first housing portion 41 covering the open upper portion of the airbag case may be cut or ruptured, and the airbag 100 may be inflated upward.

Referring to FIGS. 4 to 13, the airbag 100 may include a first chamber 110 and a second chamber 120.

The first chamber 110 is inflated by gas supplied from the inflator 52, and the second chamber 120 is inflated by gas supplied from the first chamber 110. The first chamber 110 and the second chamber 120 are in communication with each other through a vent hole part through which gas may be supplied.

The inflator 52 may be directly connected to the first chamber 110 or connected through a connecting member such as a hose. Accordingly, the gas supplied from the inflator 52 is directly supplied to the first chamber 110, and is supplied to the second chamber 120 through the vent hole part while the first chamber 110 is inflated. Accordingly, in the airbag 100, the first chamber 110 is first inflated, and then the second chamber 120 is inflated. FIG. 4 shows a state in which the second chamber 120 is being inflated at the time when the first chamber 110 is fully inflated, and FIG. 5 shows a state in which both the first chamber 110 and the second chamber 120 are fully inflated.

The first chamber 110 may be deployed from the rear of the headrest 30 and inflated. The second chamber 120 may be deployed from the front of the first chamber 110 and inflated.

A front surface of the first chamber 110 may come into direct contact with a rear surface of the headrest 30. Accordingly, the headrest 30 is supported on the first chamber 110, such that the headrest 30 may be prevented from bending in the event of a collision of the vehicle body V.

In the event of a collision of the vehicle body V, the occupant may be thrown upward due to a ramping-up behavior. In this case, the front surface of the first chamber 110 may directly support the occupant's head or neck to prevent or mitigate injury to the occupant.

The first chamber 110, which is fully inflated, may have a roughly hexahedral shape. A front-to-rear thickness from an upper end portion to an lower end portion of the first chamber 110 may be uniform or substantially uniform at the time when the first chamber 110 is fully inflated. Accordingly, the first chamber 110 may stably support the second chamber 120, the headrest 30, and the occupant's head or neck.

The second chamber 120, which is fully inflated, may have an inverted U-shape when viewed from the front of the airbag 100.

The second chamber 120 may include an upper chamber 121, a first side chamber 122, and a second side chamber 123.

The upper chamber 121 surrounds an upper side of the occupant's head. The first side chamber 122 surrounds a first side of the occupant's head, and the second side chamber 123 surrounds a second side of the occupant's head. The second side of the head is opposite to the first side; if the first side is the right side of the head, the second side may be the left side of the head.

A distance between the first side chamber 122 and the second side chamber 123, which are fully inflated, is designed to be greater than a lateral width of the headrest 30, such that a front end portion of the first side chamber 122 and a front end portion the second side chamber 123 may be deployed forward without interfering with the headrest 30.

In the present embodiment, the upper chamber 121, the first side chamber 122, and the second side chamber 123 are formed in an inverted U-shape as a whole. Accordingly, even in the event of an oblique collision in addition to frontal and rear collisions, the first side chamber 122 and the second side chamber 123 may prevent lateral shaking of the occupant's head, thereby preventing or mitigating injury.

The upper chamber 121, the first side chamber 122, and the second side chamber 123 are in communication with one another, such that gas supplied to the upper chamber 121 may be supplied to the first side chamber 122 and/or the second side chamber 123, and gas supplied to the first side chamber 122 or the second side chamber 123 may be supplied to the upper chamber 121.

A lower end portion of the first side chamber 122 and a lower end portion of the second side chamber 123 may be positioned above the occupant's shoulders, respectively. Accordingly, the first side chamber 122 and the second side chamber 123, which have been deployed, directly restrain the occupant's shoulders in the event of a collision of the vehicle body V, thereby preventing or reducing the occupant's ramping-up behavior in which the occupant is thrown upward.

A lowest end of the first chamber 110 may be disposed lower than a lowest end of the first side chamber 122 and a lowest end of the second side chamber 123. Accordingly, in response to the first side chamber 122 and the second side chamber 123 restraining both shoulders of the occupant, the first chamber 110 may support the headrest 30 and an upper portion of the seat 20.

The first chamber 110 may be in communication with the upper chamber 121, the first side chamber 122, and the second side chamber 123 through the vent hole part, respectively. Accordingly, gas supplied to the first chamber 110 may be supplied to the upper chamber 121, the first side chamber 122, and the second side chamber 123 through the vent hole part, thereby enabling the upper chamber 121, the first side chamber 122, and the second side chamber 123 to be deployed.

The vent hole part may include upper vent holes 111a and 121a, first vent holes 112a and 122a, and second vent holes 113a and 123a.

The upper vent holes 111a and 121a are formed in the first chamber 110 and the upper chamber 121, respectively, to enable fluid flow between the first chamber 110 and the upper chamber 121. The upper vent hole 111a is a vent hole formed at an upper portion of the front surface of the first chamber 110, and the upper vent hole 121a is a vent hole formed at a central portion of a rear surface of the upper chamber 121.

The front surface of the first chamber 110 and the rear surface of the upper chamber 121 may be sewn and coupled to each other. A seam formed on the front surface of the first chamber 110 and the rear surface of the upper chamber 121 may be formed to surround a periphery of the upper vent holes 111a and 121a. That is, the first chamber 110 and the upper chamber 121 may be sewn and coupled to each other to surround the entire periphery of the upper vent holes 111a and 121a. Accordingly, gas leakage may be prevented when gas is supplied through the upper vent holes 111a and 121a, and the first chamber 110 and the upper chamber 121 may be firmly coupled.

The first vent holes 112a and 122a are formed in the first chamber 110 and the first side chamber 122, respectively, to enable fluid flow between the first chamber 110 and the first side chamber 122. The first vent hole 112a is a vent hole formed on a first side (the left side in FIG. 11) of the front surface of the first chamber 110, and the first vent hole 122a is a vent hole formed on a lower portion of a rear surface of the first side chamber 122.

The front surface of the first chamber 110 and the rear surface of the first side chamber 122 may be sewn and coupled to each other. A seam formed on the front surface of the first chamber 110 and the rear surface of the first side chamber 122 may be formed to surround a periphery of the first vent holes 112a and 122a. That is, the first chamber 110 and the first side chamber 122 may be sewn and coupled to each other to surround the entire periphery of the first vent holes 112a and 122a. Accordingly, gas leakage may be prevented when gas is supplied through the first vent holes 112a and 122a, and the first chamber 110 and the first side chamber 122 may be firmly coupled.

The second vent holes 113a and 123a are formed in the first chamber 110 and the second side chamber 123, respectively, to enable fluid flow between the first chamber 110 and the second side chamber 123. The second vent hole 113a is a vent hole formed on a second side (the right side in FIG. 11) of the front surface of the first chamber 110, and the second vent hole 123a is a vent hole formed on a lower portion of a rear surface of the second side chamber 123.

The front surface of the first chamber 11 and the rear surface of the second side chamber 123 may be sewn and coupled to each other. A seam formed on the front surface of the first chamber 110 and the rear surface of the second side chamber 123 may be formed to surround a periphery of the second vent holes 113a and 123a. That is, the first chamber 110 and the second side chamber 123 may be sewn and coupled to each other to surround the entire periphery of the second vent holes 113a and 123a. Accordingly, gas leakage may be prevented when gas is supplied through the second vent holes 113a and 123a, and the first chamber 110 and the second side chamber 123 may be firmly coupled.

The first vent holes 112a and 122a and the second vent holes 113a and 123a are disposed at a lower portion of the first chamber 110, such that gas may be supplied to the first side chamber 122 and the second side chamber 123 before the first chamber 110 is fully inflated. Accordingly, the first side chamber 122 and the second side chamber 123 may be rapidly deployed to restrain both shoulders of the occupant more quickly, thereby preventing a ramping-up behavior of the occupant.

The upper vent holes 111a and 121a, the first vent holes 112a and 122a, and the second vent holes 113a and 123a may each be provided as a single hole. In this case, a diameter of the upper vent holes 111a and 121a may be larger than a diameter of the first vent holes 112a and 122a and a diameter of the second vent holes 113a and 123a.

The upper vent holes 111a and 121a, the first vent holes 112a and 122a, and the second vent holes 113a and 123a may each be provided as a plurality of holes. In this case, a total diameter of the plurality of the upper vent holes 111a and 121a may be greater than a total diameter of the plurality of the first vent holes 112a and 122a and a total diameter of the plurality of the second vent holes 113a and 123a.

The airbag device for a vehicle according to an embodiment of the present disclosure may further include a tether 130.

A first side of the tether 130 may be coupled to the front surface of the first chamber 110, and a second side of the tether 130 may be coupled to the housing 40. The tether 130 may be coupled to the first chamber 110 by sewing, and may be coupled to the housing 40 by hooking or adhesive bonding. The tether 130 may include a cord or a strap having a predetermined width.

Since the tether 130 having a predetermined length is coupled to the housing 40 and the first chamber 110, upward movement of the first chamber 110 is restricted by the tether 130 during deployment of the first chamber 110.

The tether 130 may restrict upward movement of the first chamber 110 during an initial stage of deployment of the first chamber 110, thereby guiding the first chamber 110 and the second chamber 120 to be deployed rapidly toward the occupant.

Even when the first chamber 110 is not supported by direct contact with the roof 200 of the vehicle, upward movement of the first chamber 110 and the second chamber 120 is restricted by the tether 130. Accordingly, the occupant's head or neck or the headrest 30 may be supported more stably. In addition, a fully inflated volume of the first chamber 110 may be reduced, thereby reducing weight and manufacturing costs.

Although the present disclosure has been described with reference to the embodiments illustrated in the drawings, the embodiments are merely for illustrative purposes, and those skilled in the art will appreciate that various modifications and other equivalent embodiments are possible from the embodiments. Therefore, the true technical scope of the present disclosure should be defined by the following claims.

What is claimed is:

1. An airbag device for a vehicle, the airbag device comprising:
a seat mounted to a vehicle body and configured to allow an occupant to sit thereon;
a headrest mounted to the seat and configured to support the occupant’s head;
a housing disposed at a rear of the seat; and
an airbag mounted to the housing and configured to be deployed to protect the occupant’s head or neck in the event of a collision of the vehicle body, wherein the airbag comprises:
a first chamber configured to be inflated by fluid supplied from an inflator; and
a second chamber configured to be in communication with the first chamber through a vent hole part and inflated by fluid supplied from the first chamber.

2. The airbag device of claim 1, wherein
the first chamber is configured to be deployed from a rear of the headrest and inflated, and
the second chamber is configured to be deployed from a front of the first chamber and inflated.

3. The airbag device of claim 1, wherein the first chamber is configured to come into contact with a rear surface of the headrest to support the headrest.

4. The airbag device of claim 1, wherein the second chamber, when fully inflated, has an inverted U-shape when viewed from a front of the airbag.

5. The airbag device of claim 1, wherein the second chamber comprises:
an upper chamber configured to surround an upper side of the occupant's head;
a first side chamber surrounding a first side of the occupant's head; and
a second side chamber configured to surround a second side of the occupant's head, which is opposite the first side.

6. The airbag device of claim 5, wherein a lower end portion of the first side chamber and a lower end portion of the second side chamber are positioned above the occupant’s shoulders, respectively.

7. The airbag device of claim 6, wherein the first chamber is in communication with each of the upper chamber, the first side chamber, and the second side chamber through the vent hole part.

8. The airbag device of claim 7, wherein the vent hole part comprises:
one or more first vent holes disposed in the first chamber and the first side chamber, respectively, to enable fluid flow between the first chamber and the first side chamber;
one or more second vent holes disposed in the first chamber and the second side chamber, respectively, to enable fluid flow between the first chamber and the second side chamber; and
one or more upper vent holes disposed in the first chamber and the upper chamber, respectively, to enable fluid flow between the first chamber and the upper chamber, wherein a total diameter of the one or more upper vent holes is greater than a total diameter of the first vent holes and a total diameter of the second vent holes.

9. The airbag device of claim 8, wherein the first chamber and the second chamber are coupled by sewing to surround peripheries of the first vent hole, the second vent hole, and the upper vent hole.

10. The airbag device of claim 1, further comprising a tether having a first side coupled to a front surface of the first chamber and a second side coupled to the housing to restrict upward movement of the first chamber during deployment of the first chamber.
